(19) United States
(12) Patent Application Publication
(10) Pub. No.: US 2023/0030431 A1
(43) Pub. Date: Feb. 2, 2023

(54) METHOD AND APPARATUS FOR EXTRACTING FEATURE, DEVICE, AND STORAGE MEDIUM

(71) Applicant: BEIJING BAIDU NETCOM SCIENCE TECHNOLOGY CO., LTD., Beijing (CN)

(72) Inventors: Yingying LI, Beijing (CN); Xiao TAN, Beijing (CN); Hao SUN, Beijing (CN)

(21) Appl. No.: 17/963,865

(22) Filed: Oct. 11, 2022

Related U.S. Application Data
(63) Continuation of application No. PCT/CN2022/075069, filed on Jan. 29, 2022.

(30) Foreign Application Priority Data
Apr. 13, 2021 (CN) 202110396281.7

(51) Int. Cl. G06V 10/48; G06V 10/74; G06V 10/80; G06V 10/82

(52) U.S. Cl. CPC G06V 10/48; G06V 10/761; G06V 10/80; G06V 10/82

(57) ABSTRACT

A method for extracting a feature includes: acquiring a predicted object segmentation annotation image of a (T-1)-th frame in a video and a pixel-level feature map of a T-th frame in the video, T being a positive integer greater than 2; performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame; and performing a convolution on the mapping feature map of the T-th frame using a convolution kernel of the mapping feature map of the (T-1)-th frame, to obtain a score map of the T-th frame.

### CROSS-REFERENCE TO RELATED APPLICATION

This patent application is a continuation of International Application No. PCT/CN2022/075069, filed on Jan. 29, 2022, which claims the priority from Chinese Patent Application No. 202110396281.7, filed on Apr. 13, 2021 and entitled “Method and Apparatus for Extracting Feature, Device, Storage Medium and Program Product,” the entire disclosure of which is hereby incorporated by reference.

### TECHNICAL FIELD

The present disclosure relates to the field of artificial intelligence, and specifically to computer vision and deep learning technologies.

### BACKGROUND

VOS (Video Object Segmentation) is a fundamental task in the field of computer vision, and has a great many potential application scenarios, for example, augmented reality and autonomous driving. In a semi-supervised video object segmentation, it is required to perform a feature extraction in a situation where a video sequence only has an initial mask, to segment an object.

### SUMMARY

Embodiments of the present disclosure provide a method and apparatus for extracting a feature, a device, and a storage medium.

In a first aspect, an embodiment of the present disclosure provides a method for extracting a feature, including: acquiring a predicted object segmentation annotation image of a (T-1)-th frame in a video and a pixel-level feature map of a T-th frame in the video, T being a positive integer greater than 2; performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame; and performing a convolution on the mapping feature map of the T-th frame using a convolution kernel of the mapping feature map of the (T-1)-th frame, to obtain a score map of the T-th frame, where each point of the score map represents a similarity between each position of the pixel-level feature map of the T-th frame and the predicted object segmentation annotation image of the (T-1)-th frame.

In a second aspect, an embodiment of the present disclosure provides an apparatus for extracting a feature, including: an acquiring module, configured to acquire a predicted object segmentation annotation image of a (T-1)-th frame in a video and a pixel-level feature map of a T-th frame in the video, T being a positive integer greater than 2; a mapping module, configured to perform respectively feature mapping on the predicted object segmentation annotation image of the (T-1)-th frame and the pixel-level feature map of the T-th frame, to obtain a mapping feature map of the (T-1)-th frame and a mapping feature map of the T-th frame; and a convolution module, configured to perform a convolution on the mapping feature map of the T-th frame using a convolution kernel of the mapping feature map of the (T-1)-th frame, to obtain a score map of the T-th frame, where each point of the score map represents a similarity between each position of the pixel-level feature map of the T-th frame and the predicted object segmentation annotation image of the (T-1)-th frame.

In a third aspect, an embodiment of the present disclosure provides an electronic device, including: at least one processor; and a memory, in communication with the at least one processor. The memory stores instructions executable by the at least one processor, and the instructions are executed by the at least one processor, to enable the at least one processor to perform the method according to any implementation in the first aspect.

In a fourth aspect, an embodiment of the present disclosure provides a non-transitory computer readable storage medium, storing a computer instruction. The computer instruction is used to cause a computer to perform the method according to any implementation in the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

Through the detailed description of non-limiting embodiments given with reference to the following accompany drawings, other features, objectives and advantages of the present disclosure will become more apparent. The accompanying drawings are used for a better understanding of the scheme, and do not constitute a limitation to the present disclosure. Here:

FIG. 1 illustrates an exemplary system architecture in which an embodiment of the present disclosure may be applied;

FIG. 2 is a flowchart of a method for extracting a feature according to an embodiment of the present disclosure;

FIG. 3 is a diagram of a scenario where the method for extracting a feature according to an embodiment of the present disclosure can be implemented;

FIG. 4 is a flowchart of a method for fusing features according to an embodiment of the present disclosure;

FIG. 5 is a flowchart of a method for predicting a segmentation according to an embodiment of the present disclosure;

FIG. 6 is a diagram of a scenario where the method for predicting a segmentation according to an embodiment of the present disclosure can be implemented;

FIG. 7 is a schematic structural diagram of an apparatus for extracting a feature according to an embodiment of the present disclosure; and

FIG. 8 is a block diagram of an electronic device used to implement the method for extracting a feature according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

It should be noted that the embodiments in the present disclosure and the features in the embodiments may be combined with each other on a non-conflict basis. The present disclosure will be described below in detail with reference to the accompanying drawings and in combination with the embodiments.

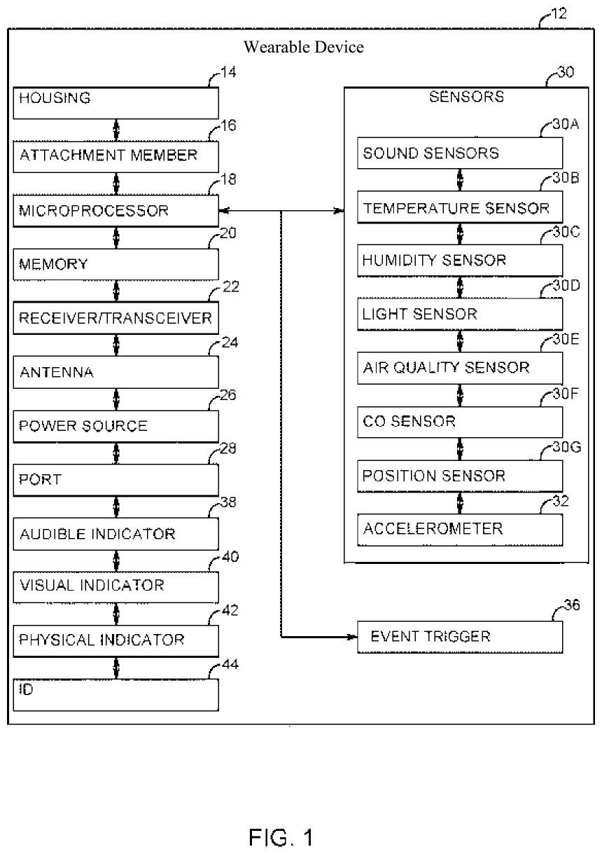

FIG. 1 illustrates an exemplary system architecture 100 in which an embodiment of a method for extracting a feature or an apparatus for extracting a feature according to the present disclosure may be applied.

As shown in FIG. 1, the system architecture 100 may include a video collection device 101, a network 102 and a server 103. The network 102 serves as a medium providing a communication link between the video collection device 101 and the server 103. The network 102 may include various types of connections, for example, wired or wireless communication links, or optical fiber cables.

The video collection device 101 may interact with the server 103 via the network 102 to receive or send images, etc.

The video collection device 101 may be hardware or software. When being the hardware, the video collection device 101 may be various electronic devices with cameras. When being the software, the video collection device 101 may be installed in the above electronic devices. The video collection device 101 may be implemented as a plurality of pieces of software or a plurality of software modules, or may be implemented as a single piece of software or a single software module, which will not be specifically defined here.

The server 103 may provide various services. For example, the server 103 may perform processing such as an analysis on a video stream acquired from the video collection device 101, and generate a processing result (e.g., a score map of a video frame in a video).

It should be noted that the server 103 may be hardware or software. When being the hardware, the server 103 may be implemented as a distributed server cluster composed of a plurality of servers, or may be implemented as a single server. When being the software, the server 103 may be implemented as a plurality of pieces of software or a plurality of software modules (e.g., software or software modules for providing a distributed service), or may be implemented as a single piece of software or a single software module, which will not be specifically defined here.

It should be noted that the method for extracting a feature provided in the embodiments of the present disclosure is generally performed by the server 103, and correspondingly, the apparatus for extracting a feature is generally provided in the server 103.

It should be appreciated that the numbers of the video collection devices, the networks, and the servers in FIG. 1 are merely illustrative. Any number of video collection devices, networks, and servers may be provided based on actual requirements.

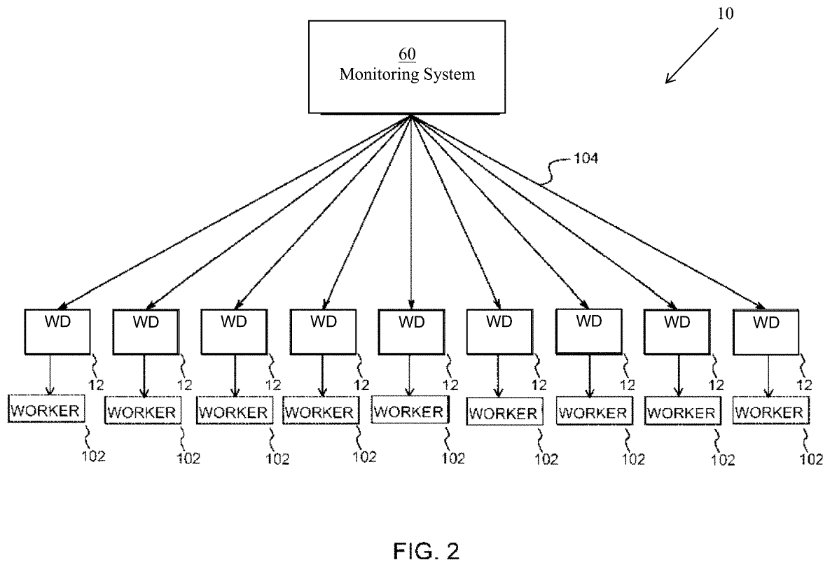

Further referring to FIG. 2, FIG. 2 illustrates a flow 200 of a a method for extracting a feature according to n embodiment ofthe present disclosure. The method for extracting a feature includes the following steps.

Step 201, acquiring a predicted object segmentation annotation image of a (T-1)-th frame in a video and a pixel-level feature map of a T-th frame in the video.

In this embodiment, an executing body (e.g., the server 103 shown in FIG. 1) of the method for extracting a feature may acquire the predicted object segmentation annotation image (Prediction T-1) of the (T-1)-th frame in the video and the pixel-level feature map (Pixel-level Embedding) of the T-th frame in the video. Here, T is a positive integer greater than 2.

Generally, a video collection device may collect a video within its camera range. When an object appears in the camera range of the video collection device, there will be the object in the collected video. Here, the object may be any tangible object existing in the real world, including, but not limited to, a human, an animal, a plant, a building, an item, and the like. The predicted object segmentation annotation image of the (T-1)-th frame may be a predicted annotation image used to segment an object in the (T-1)-th frame. As an example, the predicted object segmentation annotation image may be an image that is generated by annotating the edge of the object in the (T-1)-th frame. As another example, the predicted object segmentation annotation image may be an image that is generated by annotating the edge of the object in the (T-1)-th frame and then setting respectively a pixel belonging to the object and a pixel not belonging to the object to a different pixel value. The pixel-level feature map of the T-th frame may be obtained by performing a pixel-level feature extraction using a feature extraction network, and is used to represent a pixel-level feature of the T-th frame.

It should be noted that the predicted object segmentation annotation image of the (T-1)-th frame may be obtained by performing a prediction using the segmentation prediction method provided in the embodiment of the present disclosure, or may be obtained by performing a prediction using an other VOS network, which is not specifically limited here. The feature extraction network used to extract the pixel-level feature map of the T-th frame may be a backbone network (Backbone) in a CFBI (Collaborative Video Object Segmentation by Foreground-Background Integration) network, or may be a backbone network in an other VOS network, which is not specifically limited here.

Step 202, performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame.

In this embodiment, the above executing body may respectively perform the feature mapping on the predicted object segmentation annotation image of the (T-1)-th frame and the pixel-level feature map of the T-th frame, to obtain the mapping feature map of the (T-1)-th frame and the mapping feature map of the T-th frame. Here, the mapping feature map of the (T-1)-th frame and the mapping feature map of the T-th frame are in the same feature space. For example, for a predicted object segmentation annotation image of 127×127 x3, a mapping feature map of 6×6×128 is obtained through a feature mapping operation. Similarly, for a pixel-level feature map of 255 ×255×3, a mapping feature map of 22×22×128 is obtained through a feature mapping operation.

In some alternative implementations of this embodiment, by using a transformation matrix, the predicted object segmentation annotation image of the (T-1)-th frame and the pixel-level feature map of the T-th frame are mapped from one feature space to an other feature space, and thus, the mapping feature map of the (T-1)-th frame and the mapping feature map of the T-th frame can be obtained. Here, the transformation matrix may perform a linear transformation on an image, to map the image from one space to an other space.

In some alternative implementations of this embodiment, the above executing body may use a convolutional layer and a pooling layer in a CNN (Convolutional Neural Network) to respectively map the predicted object segmentation annotation image of the (T-1)-th frame and the pixel-level feature map of the T-th frame to a preset feature space, and thus, the mapping feature map of the (T-1)-th frame and the mapping feature map of the T-th frame can be obtained. Here, by performing mapping using a deep learning method, not only a linear transformation can be performed on an image, but also a non-linear transformation can be performed on the image. By setting different convolutional layers and different pooling layers, the image can be mapped to any space, resulting in a stronger flexibility.

Step 203, performing a convolution on the mapping feature map of the T-th frame using a convolution kernel of the mapping feature map of the (T-1)-th frame, to obtain a score map of the T-th frame.

In this embodiment, the above executing body may perform the convolution on the mapping feature map of the T-th frame using the convolution kernel of the mapping feature map of the (T-1)-th frame, to obtain the score map of the T-th frame. Here, each point of the score map may represent a similarity between each position of the pixel-level feature map of the T-th frame and the predicted object segmentation annotation image of the (T-1)-th frame. For example, a convolution is performed on a mapping feature map of 22×22×128 using the convolution kernel 6X6 of a mapping feature map of 6×6×128, to obtain a score map of 17×17×1. Here, a point of the score map of 17×17 xl may represent a similarity between a region of 15×15×3 of a pixel-level feature map of 255×255×3 and a predicted object segmentation annotation image of 127×127×3. One point of the score map corresponds to one region of 15×15×3 of the pixel-level feature map.

In addition, the above executing body may calculate a position of the T-th frame with a highest similarity based on the score map of the T-th frame, and inversely calculate the position of the object in the T-1-th frame, thereby verifying the accuracy of the score map of the T-th frame.

According to the method for extracting a feature provided in the embodiment of the present disclosure, the predicted object segmentation annotation image of the (T-1)-th frame in the video and the pixel-level feature map of the T-th frame in the video are first acquired; the feature mapping is respectively performed on the predicted object segmentation annotation image of the (T-1)-th frame and the pixel-level feature map of the T-th frame, to obtain the mapping feature map of the (T-1)-th frame and the mapping feature map of the T-th frame; and finally, the convolution is performed on the mapping feature map of the T-th frame using the convolution kernel of the mapping feature map of the (T-1)-th frame, to obtain the score map of the T-th frame. The feature of a next frame is extracted in combination with the characteristic of a previous frame, such that the information between the previous frame and the next frame can be better extracted. Moreover, the pixel-level feature map of the next frame is inputted as a whole, to directly calculate similarity matching between the feature map of the previous frame and the feature map of the next frame, thereby saving the computational efforts.

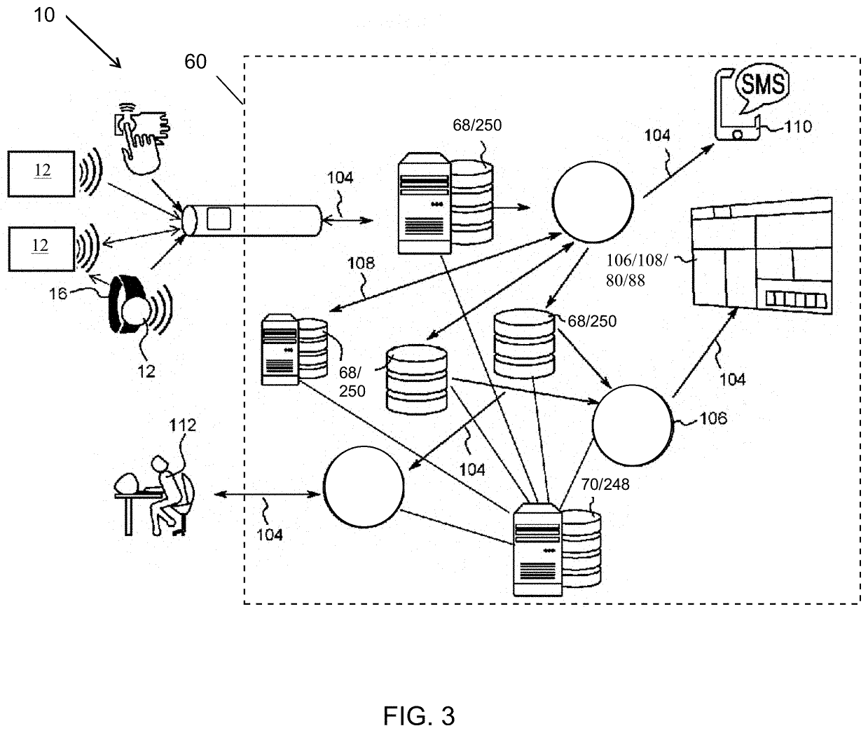

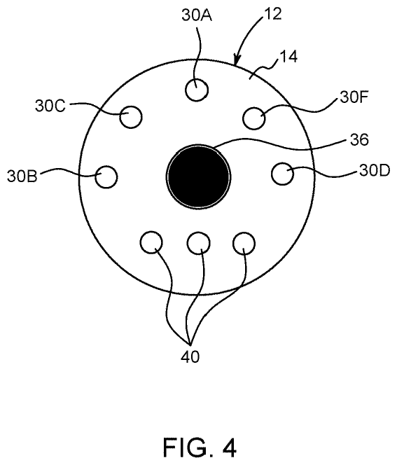

For ease of understanding, FIG. 3 is a diagram of a scenario where the method for extracting a feature according to the embodiment of the present disclosure can be implemented. As shown in FIG. 3, z represents a predicted object segmentation annotation image of 127×127×3 of a (T-1)-th frame, x represents a pixel-level feature map of 255×255×3 of a T-th frame, and φ represents a feature mapping operation through which an original image is mapped to a specific feature space, this operation being performed using a convolutional layer and a pooling layer in a CNN. After φ is performed on z, a mapping feature map of 6×6×128 is obtained. Similarly, after φ is performed on x, a mapping feature map of 22^{x} 22×128 is obtained. In addition,*represents a convolution operation. After a convolution is performed on the mapping feature map of 22×22×128 using a convolution kernel 6×6 of the mapping feature map of 6×6×128, a score map of 17 xl7×1 is obtained. A point of the score map of 17 xl7×1 may represent a similarity between a region of 15×15×3 of the pixel-level feature map of 255×255×3 and the predicted object segmentation annotation image of 127×127×3. One point of the score map corresponds to one region of 15×15×3 of the pixel-level feature map.

Further referring to FIG. 4, FIG. 4 illustrates a flow 400 of a method for fusing features according to an embodiment of the present disclosure. The method for fusing features includes the following steps.

Step 401, acquiring a predicted object segmentation annotation image of a (T-1)-th frame in a video and a pixel-level feature map of a T-th frame in the video.

Step 402, performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame.

Step 403, performing a convolution on the mapping feature map of the T-th frame using a convolution kernel of the mapping feature map of the (T-1)-th frame, to obtain a score map of the T-th frame.

In this embodiment, the detailed operations of steps 401-403 have been described in detail in steps 201-203 in the embodiment shown in FIG. 2, and thus will not be repeatedly described here.

Step 404, acquiring a pixel-level feature map of a reference frame in the video, and performing matching on the pixel-level feature map of the T-th frame and the pixel-level feature map of the reference frame to obtain a first matching feature map of the T-th frame.

In this embodiment, an executing body (e.g., the server 103 shown in FIG. 1) of the method for extracting a feature may acquire the pixel-level feature map of the reference frame in the video, and perform the matching on the pixel-level feature map of the T-th frame and the pixel-level feature map of the reference frame to obtain the first matching feature map of the T-th frame. Here, the reference frame has a segmentation annotation image, and is generally the first frame in the video. By performing a segmentation annotation on an object in the reference frame, the segmentation annotation image of the reference frame can be obtained. The segmentation annotation here is generally a manual segmentation annotation.

Generally, when applied in a FEELVOS (Fast End-to-End Embedding Learning for Video Object Segmentation) network, the above executing body may directly perform the matching on the pixel-level feature map of the T-th frame and the pixel-level feature map of the reference frame. When applied in a CFBI network, the above executing body may first separate the pixel-level feature map of the reference frame into a foreground pixel-level feature map and background pixel-level feature map of the reference frame, and then perform the matching on the pixel-level feature map of the T-th frame and the foreground pixel-level feature map and background pixel-level feature map of the reference frame. Here, a foreground refers to an object in the screen that is located before the object (target) to such an extent as to be close to the camera. A background refers to an object in the screen that is located behind the object (target) and away from the camera. The first matching feature map is a pixel-level feature map, each point of which may represent a degree of matching between each point of the pixel-level feature map of the T-th frame and each point of the pixel-level feature map of the reference frame.

It should be noted that, for the approach of acquiring the pixel-level feature map of the reference frame, reference may be made to the approach of acquiring the pixel-level feature map of the T-th frame in the embodiment shown in FIG. 2, and thus, the details will not be repeatedly described here.

Step 405, acquiring a pixel-level feature map of the (T-1)-th frame, and performing matching on the pixel-level feature map of the T-th frame and the pixel-level feature map of the (T-1)-th frame to obtain a second matching feature map of the T-th frame.

In this embodiment, the above executing body may acquire the pixel-level feature map of the (T-1)-th frame, and perform the matching on the pixel-level feature map of the T-th frame and the pixel-level feature map of the (T-1)-th frame to obtain the second matching feature map of the T-th frame.

Generally, the above executing body may directly perform the matching on the pixel-level feature map of the T-th frame and the pixel-level feature map of the (T-1)-th frame. Alternatively, the above executing body may first separate the pixel-level feature map of the (T-1)-th frame into a foreground pixel-level feature map (Pixel-level FG) and background pixel-level feature map (Pixel-level BG) of the (T-1)-th frame, and then perform the matching on the pixel-level feature map of the T-th frame and the foreground pixel-level feature map and background pixel-level feature map of the (T-1)-th frame. The second matching feature map is a pixel-level feature map, each point of which may represent a degree of matching between each point of the pixel-level feature map of the T-th frame and each point of the pixel-level feature map of the (T-1)-th frame.

It should be noted that, for the approach of acquiring the pixel-level feature map of the (T-1)-th frame, reference may be made to the approach of acquiring the pixel-level feature map of the T-th frame in the embodiment shown in FIG. 2, and thus, the details will not be repeatedly described here.

Step 406, fusing the score map, the first matching feature map and the second matching feature map of the T-th frame to obtain a fused pixel-level feature map.

In this embodiment, the above executing body may fuse the score map, the first matching feature map and the second matching feature map of the T-th frame to obtain the fused pixel-level feature map. For example, by performing a concat operation on the score map, the first matching feature map and the second matching feature map of the T-th frame, the fused pixel-level feature map can be obtained.

It should be noted that the three parts (steps 401-403, step 404 and step 405) may be performed simultaneously, or a part may be performed prior to the other parts. The execution order of the three parts is not limited here.

According to the method for fusing features provided in the embodiment of the present disclosure, the feature of a next frame is extracted in combination with the characteristic of a previous frame, such that the information between the previous frame and the next frame can be better extracted. The feature mapping is respectively performed based on the reference frame and the previous frame, and the network structure is simple and fast, and thus, the matching feature of the next frame can be quickly obtained, thereby reducing the workload during the feature matching. The score map, the first matching feature map and the second matching feature map of the T-th frame are fused to obtain the fused pixel-level feature map, such that the fused pixel-level feature map takes the characteristic of the previous frame and the next frame into full consideration, which makes the information content more abundant, thereby containing more information required for the object segmentation.

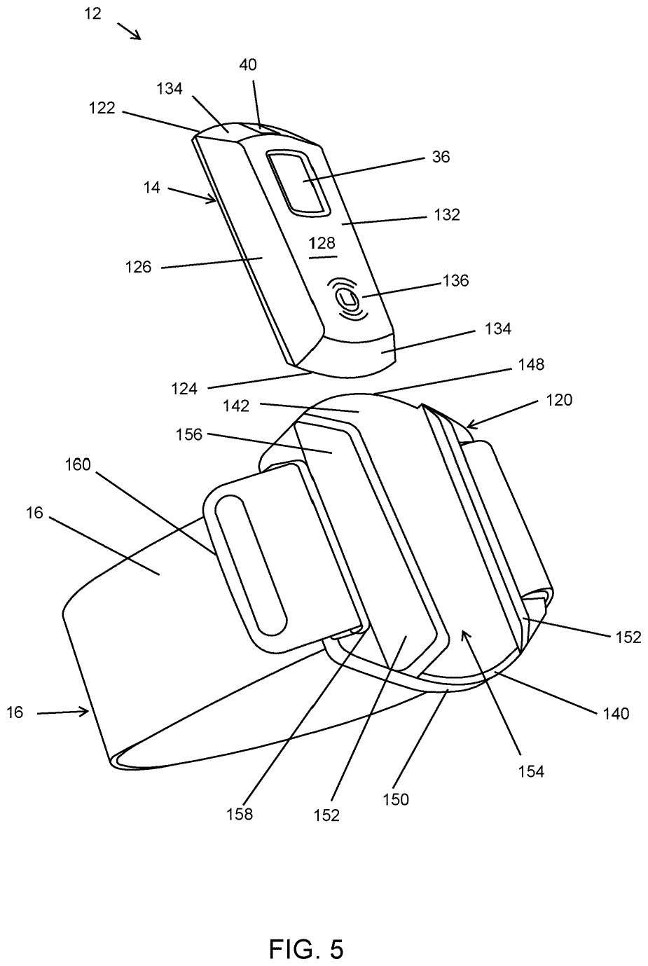

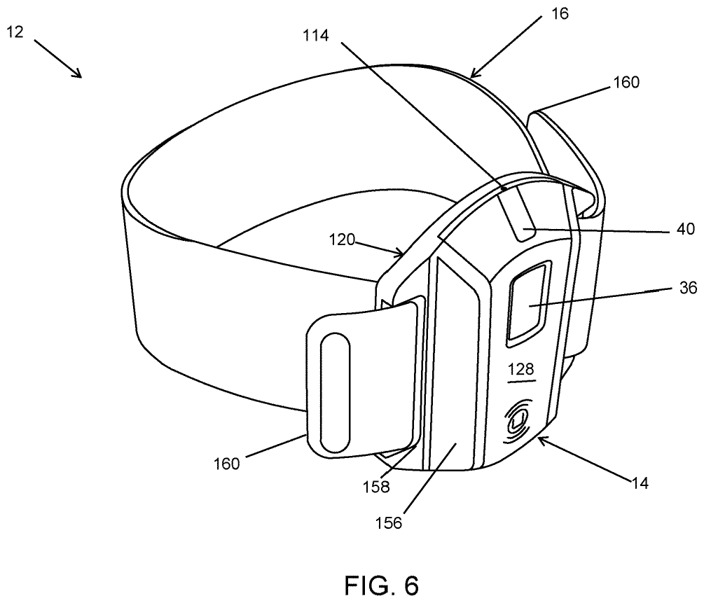

Further referring to FIG. 5, FIG. 5 illustrates a flow 500 of a method for predicting a segmentation according to an embodiment of the present disclosure. The method for predicting a segmentation includes the following steps.

Step 501, acquiring a predicted object segmentation annotation image of a (T-1)-th frame in a video and a pixel-level feature map of a T-th frame in the video.

Step 502, performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame.

Step 503, performing a convolution on the mapping feature map of the T-th frame using a convolution kernel of the mapping feature map of the (T-1)-th frame, to obtain a score map of the T-th frame.

In this embodiment, the detailed operations of steps 501-503 have been described in detail in steps 401-403 in the embodiment shown in FIG. 4, and thus will not be repeatedly described here.

Step 504, down-sampling a segmentation annotation image of a reference frame to obtain a mask of the reference frame.

In this embodiment, an executing body (e.g., the server 103 shown in FIG. 1) of the method for extracting a feature may down-sample the segmentation annotation image (Groundtruth) of the reference frame to obtain the mask of the reference frame.

Here, the segmentation annotation image of the reference frame may be an image that is generated by annotating the edge of an object in the reference frame and then setting respectively a pixel belonging to the object and a pixel not belonging to the object to a different pixel value. As an example, the pixel belonging to the object is set to 1, and the pixel not belonging to the object is set to 0. As another example, the pixel belonging to the object is set to 0, and the pixel not belonging to the object is set to 1. The down-sampling refers to reducing an image, and the main purpose is to make the image conform to the size of a display region; and generate a thumbnail corresponding to the image. The principle of the down-sampling is that, for an image of a size M*N, a region within a window of s*s of the image is changed into one pixel (the value of which is usually the value of a pixel point, i.e., the mean value of all pixels within the window), and thus, an image of a size (M/s)*(N/s) is obtained. Here, M, N and s are positive integers, and s is a common divisor of M and N. The mask of the reference frame may be used to extract a region of interest from the pixel-level feature map of the reference frame. For example, by performing an AND operation on the mask of the reference frame and the pixel-level feature map of the reference frame, a region-of-interest image can be obtained. Here, the region-of-interest image includes only one of a foreground or a background.

Step 505, inputting the reference frame into a pre-trained feature extraction network to obtain a pixel-level feature map of the reference frame.

In this embodiment, the above executing body may input the reference frame into the pre-trained feature extraction network to obtain the pixel-level feature map of the reference frame. Here, the reference frame is inputted into a backbone network in a CFBI network to perform a pixel-level feature extraction, and thus, the pixel-level feature map of the reference frame can be obtained.

Step 506, performing a pixel-level separation on the pixel-level feature map of the reference frame using the mask of the reference frame to obtain a foreground pixel-level feature map and background pixel-level feature map of the reference frame.

In this embodiment, the above executing body may perform the pixel-level separation (Pixel Separation) on the pixel-level feature map of the reference frame using the mask of the reference frame, to obtain the foreground pixel-level feature map and background pixel-level feature map of the reference frame.

For example, for a mask of which the foreground pixel is 1 and the background pixel is 0, an AND operation is performed on the mask and the pixel-level feature map, to obtain a foreground pixel-level feature map. For a mask of which the foreground pixel is 0 and the background pixel is 1, an AND operation is performed on the mask and the pixel-level feature map, to obtain a background pixel-level feature map.

Step 507, performing foreground-background global matching on the pixel-level feature map of the T-th frame and the foreground pixel-level feature map and background pixel-level feature map of the reference frame, to obtain a first matching feature map of the T-th frame.

In this embodiment, the above executing body may perform the foreground-background global matching (F-G Global Matching) on the pixel-level feature map of the T-th frame and the foreground pixel-level feature map and background pixel-level feature map of the reference frame, to obtain the first matching feature map of the T-th frame.

Generally, when matching with the pixels of the reference frame is performed, a matching search is performed on the full flat face of the T-th frame. Specifically, global matching on the pixel-level feature map of the T-th frame and the foreground pixel-level feature map of the reference frame and global matching on the pixel-level feature map of the T-th frame and the background pixel-level feature map of the reference frame are respectively performed.

Step 508, down-sampling the predicted object segmentation annotation image of the (T-1)-th frame to obtain a mask of the (T-1)-th frame.

In this embodiment, the above executing body may down-sample the predicted object segmentation annotation image of the (T-1)-th frame to obtain the mask of the (T-1)-th frame.

Here, the segmentation annotation image of the (T-1)-th frame may be an image that is generated by annotating the edge of an object in the (T-1)-th frame and then setting respectively a pixel belonging to the object and a pixel not belonging to the object to a different pixel value. As an example, the pixel belonging to the object is set to 1, and the pixel not belonging to the object is set to 0. As another example, the pixel belonging to the object is set to 0, and the pixel not belonging to the object is set to 1. The mask of the (T-1)-th frame may be used to extract a region of interest from the pixel-level feature map of the (T-1)-th frame. For example, by performing an AND operation on the mask of the (T-1)-th frame and the pixel-level feature map of the (T-1)-th frame, a region-of-interest image can be obtained. Here, the region-of-interest image includes only one of a foreground or a background.

Step 509, inputting the (T-1)-th frame into the pre-trained feature extraction network to obtain a pixel-level feature map of the (T-1)-th frame.

In this embodiment, the above executing body may input the (T-1)-th frame into the pre-trained feature extraction network to obtain the pixel-level feature map of the (T-1)-th frame. Here, the (T-1)-th frame is inputted into the backbone network in the CFBI network to perform a pixel-level feature extraction, and thus, the pixel-level feature map of the (T-1)-th frame can be obtained.

Step 510, performing a pixel-level separation on the pixel-level feature map of the (T-1)-th frame using the mask of the (T-1)-th frame to obtain a foreground pixel-level feature map and background pixel-level feature map of the (T-1)-th frame.

In this embodiment, the above executing body may perform the pixel-level separation on the pixel-level feature map of the (T-1)-th frame using the mask of the (T-1)-th frame, to obtain the foreground pixel-level feature map and background pixel-level feature map of the (T-1)-th frame.

For example, for a mask of which the foreground pixel is 1 and the background pixel is 0, an AND operation is performed on the mask and the pixel-level feature map, to obtain a foreground pixel-level feature map. For a mask of which the foreground pixel is 0 and the background pixel is 1, an AND operation is performed on the mask and the pixel-level feature map, to obtain a background pixel-level feature map.

Step 511, performing foreground-background multi-local matching on the pixel-level feature map of the T-th frame and the foreground pixel-level feature map and background pixel-level feature map of the (T-1)-th frame, to obtain a second matching feature map of the T-th frame.

In this embodiment, the above executing body may perform the foreground-background multi-local matching (F-G Multi-Local Matching) on the pixel-level feature map of the T-th frame and the foreground pixel-level feature map and background pixel-level feature map of the (T-1)-th frame, to obtain the second matching feature map of the T-th frame.

Generally, when matching with the pixels of the (T-1)-th frame is performed, since the range of an inter-frame motion is limited, a matching search will be performed in the domain of the pixels of the (T-1)-th frame. Since different videos tend to have different motion velocities, a form of multi-window (domain) matching is employed to make the network more robust in handling objects at different motion velocities. Specifically, multi-local matching on the pixel-level feature map of the T-th frame and the foreground pixel-level feature map of the (T-1)-th frame and multi-local matching on the pixel-level feature map of the T-th frame and the background pixel-level feature map of the (T-1)-th frame are respectively performed. Here, the multi-local matching refers to that a plurality of windows from small to large are provided, and local matching is performed one time in one window.

Step 512, fusing the score map, the first matching feature map and the second matching feature map of the T-th frame to obtain a fused pixel-level feature map.

In this embodiment, the detailed operation of step 512 has been described in detail in step 406 in the embodiment shown in FIG. 4, and thus will not be repeatedly described here.

Step 513, performing global pooling on the foreground pixel-level feature map and background pixel-level feature map of the reference frame on a feature channel, to obtain a foreground instance-level feature vector and background instance-level feature vector of the reference frame.

In this embodiment, the above executing body may perform the global pooling on the foreground pixel-level feature map and background pixel-level feature map of the reference frame on the feature channel, to obtain the foreground instance-level feature vector (Instance-level FG) and background instance-level feature vector (Instance-level BG) of the reference frame.

Generally, the global pooling is performed on the foreground pixel-level feature map and the background pixel-level feature map on the feature channel, and thus, a pixel-scale feature map is transformed into an instance-scale pooling vector. The pooling vector will adjust a feature channel in the collaborative ensemble-learning model of the CFBI network based on an attention mechanism. As a result, the network can better acquire instance-scale information.

Step 514, performing global pooling on the foreground pixel-level feature map and background pixel-level feature map of the (T-1)-th frame on a feature channel, to obtain a foreground instance-level feature vector and background instance-level feature vector of the (T-1)-th frame.

In this embodiment, the above executing body may perform the global pooling on the foreground pixel-level feature map and background pixel-level feature map of the (T-1)-th frame on the feature channel, to obtain the foreground instance-level feature vector and background instance-level feature vector of the (T-1)-th frame.

Generally, the global pooling is performed on the foreground pixel-level feature map and the background pixel-level feature map on the feature channel, and thus, a pixel-scale feature map is transformed into an instance-scale pooling vector. The pooling vector will adjust a feature channel in the collaborative ensemble-learning model of the CFBI network based on an attention mechanism. As a result, the network can better acquire instance-scale information.

Step 515, fusing the foreground instance-level feature vector and background instance-level feature vector of the reference frame and the foreground instance-level feature vector and background instance-level feature vector of the (T-1)-th frame, to obtain a fused instance-level feature vector.

In this embodiment, the above executing body may fuse the foreground instance-level feature vector and background instance-level feature vector of the reference frame and the foreground instance-level feature vector and background instance-level feature vector of the (T-1)-th frame, to obtain the fused instance-level feature vector. For example, a concat operation is performed on the foreground instance-level feature vector and background instance-level feature vector of the reference frame and the foreground instance-level feature vector and background instance-level feature vector of the (T-1)-th frame, and thus, the fused instance-level feature vector can be obtained.

Step 516, inputting a low-level pixel-level feature map of the T-th frame, the fused pixel-level feature map, and the fused instance-level feature vector into a collaborative ensemble-learning model, to obtain a predicted object segmentation annotation image of the T-th frame.

In this embodiment, the above executing body may input the low-level pixel-level feature map of the T-th frame, the fused pixel-level feature map and the fused instance-level feature vector into the collaborative ensemble-learning model, to obtain the predicted object segmentation annotation image of the T-th frame (Prediction T). The T-th frame is segmented based on the predicted object segmentation annotation image of the T-th frame, and thus, the object in the T-th frame can be obtained.

In order to implicitly summarize pixel-level and instance-level information learned from the foreground and the background, the collaborative ensemble-learning model is employed to construct a large receiving field to achieve a precise prediction.

According to the method for predicting a segmentation provided in the embodiment of the present disclosure, learning is not only embedded from foreground pixels but also embedded from background pixels for a collaboration, and thus, a contrast between the features of foreground and background is formed to alleviate a background chaos, thereby improving the accuracy of a segmentation prediction result. Under the collaboration of the foreground pixels and the background pixels, the embedding matching is further performed from the pixel level and the instance level. For the pixel-level matching, the robustness of the local matching at various target movement velocities is improved. For the instance-level matching, an attention mechanism is designed, which effectively enhances the pixel-level matching. An idea of tracking the network is added based on the CFBI network, such that the information between a previous frame and a next frame can be better extracted. The addition is equivalent to an addition of a layer of supervised signal to the CFBI network, and the extracted feature can be more representative of the requirement of the model, thereby improving the segmentation effect of the network.

It should be noted that the method for extracting a feature can be used not only in the CFBI network but also in other VOS networks, and the position where the network is embedded can be correspondingly adjusted according to actual situations.

For ease of understanding, FIG. 6 is a diagram of a scenario where the method for predicting a segmentation according to the embodiment of the present disclosure can be implemented. As shown in FIG. 6, the first frame, the (T-1)-th frame and the T-th frame in a video are inputted into a Backbone in a CFBI network to obtain the Pixel-level Embedding of the first frame, the (T-1)-th frame and the T-th frame. The Groundtruth of the first frame and the Prediction T-1 of the (T-1)-th frame are down-sampled to obtain the Masks of the first frame and the (T-1)-th frame. A convolution is performed on the mapping feature map of the Pixel-level Embedding of the T-th frame using the convolution kernel of the mapping feature map of the Prediction T-1 of the (T-1)-th frame, to obtain the Score map of the T-th frame. Pixel Separation is performed on the Pixel-level Embedding of the first frame using the Mask of the first frame, to obtain the Pixel-level FG and Pixel-level BG of the first frame. F-G Global Matching is performed on the Pixel-level Embedding of the T-th frame and the Pixel-level FG and Pixel-level BG of the first frame, to obtain the first matching feature map of the T-th frame. Pixel Separation is performed on the Pixel-level Embedding of the (T-1)-th frame using the Mask of the (T-1)-th frame, to obtain the Pixel-level FG and Pixel-level BG of the (T-1)-th frame. F-G Multi-Local Matching is performed on the Pixel-level Embedding of the T-th frame and the Pixel-level FG and Pixel-level BG of the (T-1)-th frame, to obtain the second matching feature map of the T-th frame. Global pooling is performed on the Pixel-level FG and Pixel-level BG of the first frame and the Pixel-level FG and Pixel-level BG of the (T-1)-th frame on the feature channel, to obtain the Instance-level FG and Instance-level BG of the first frame and the Instance-level FG and Instance-level BG of the (T-1)-th frame. A concat operation is performed on the Score map, the first matching feature map and the second matching feature map of the T-th frame. Meanwhile, a concat operation is performed on the Instance-level FG and Instance-level BG of the first frame and the Instance-level FG and Instance-level BG of the (T-1)-th frame. The fused feature is inputted into the Collaborative ensemble-learning model, together with the low-level pixel-level feature map of the T-th frame, and thus, the Prediction T of the T-th frame can be obtained.

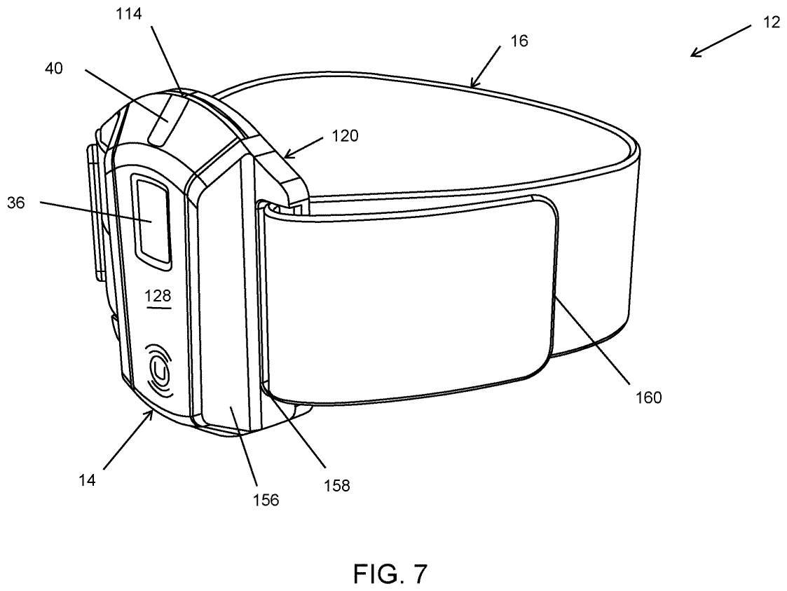

Further referring to FIG. 7, as an implementation of the method shown in the above drawings, the present disclosure provides an embodiment of an apparatus for extracting a feature. The embodiment of the apparatus corresponds to the embodiment of the method shown in FIG. 2, and the apparatus may be applied in various electronic devices.

As shown in FIG. 7, the apparatus 700 for extracting a feature in this embodiment may include: an acquiring module 701, a mapping module 702 and a convolution module 703. Here, the acquiring module 701 is configured to acquire a predicted object segmentation annotation image of a (T-1)-th frame in a video and a pixel-level feature map of a T-th frame in the video, T being a positive integer greater than 2. The mapping module 702 is configured to perform respectively feature mapping on the predicted object segmentation annotation image of the (T-1)-th frame and the pixel-level feature map of the T-th frame, to obtain a mapping feature map of the (T-1)-th frame and a mapping feature map of the T-th frame. The convolution module 703 is configured to perform a convolution on the mapping feature map of the T-th frame using a convolution kernel of the mapping feature map of the (T-1)-th frame, to obtain a score map of the T-th frame, where each point of the score map represents a similarity between each position of the pixel-level feature map of the T-th frame and the predicted object segmentation annotation image of the (T-1)-th frame.

In this embodiment, for specific processes of the acquiring module 701, the mapping module 702 and the convolution module 703 in the apparatus 700 for extracting a feature, and their technical effects, reference may be respectively made to the related descriptions of steps 201-203 in the corresponding embodiment of FIG. 2, and thus, the details will not be repeatedly described here.

In some alternative implementations of this embodiment, the mapping module 702 is further configured to: use a convolutional layer and a pooling layer in a convolutional neural network to respectively map the predicted object segmentation annotation image of the (T-1)-th frame and the pixel-level feature map of the T-th frame to a preset feature space.

In some alternative implementations of this embodiment, the apparatus 700 for extracting a feature further includes: a first matching module, configured to acquire a pixel-level feature map of a reference frame in the video and perform matching on the pixel-level feature map of the T-th frame and the pixel-level feature map of the reference frame to obtain a first matching feature map of the T-th frame, where the reference frame has a segmentation annotation image; a second matching module, configured to acquire a pixel-level feature map of the (T-1)-th frame and perform matching on the pixel-level feature map of the T-th frame and the pixel-level feature map of the (T-1)-th frame to obtain a second matching feature map of the T-th frame; and a first fusing module, configured to fuse the score map, the first matching feature map and the second matching feature map of the T-th frame to obtain a fused pixel-level feature map.

In some alternative implementations of this embodiment, the first matching module is further configured to: down-sample a segmentation annotation image of the reference frame to obtain a mask of the reference frame; input the reference frame into a pre-trained feature extraction network to obtain the pixel-level feature map of the reference frame; perform a pixel-level separation on the pixel-level feature map of the reference frame using the mask of the reference frame to obtain a foreground pixel-level feature map and background pixel-level feature map of the reference frame; and perform foreground-background global matching on the pixel-level feature map of the T-th frame and the foreground pixel-level feature map and background pixel-level feature map of the reference frame, to obtain the first matching feature map of the T-th frame.

In some alternative implementations of this embodiment, the second matching module is further configured to: down-sample the predicted object segmentation annotation image of the (T-1)-th frame to obtain a mask of the (T-1)-th frame; input the (T-1)-th frame into the pre-trained feature extraction network to obtain the pixel-level feature map of the (T-1)-th frame; perform a pixel-level separation on the pixel-level feature map of the (T-1)-th frame using the mask of the (T-1)-th frame to obtain a foreground pixel-level feature map and background pixel-level feature map of the (T-1)-th frame; and perform foreground-background multi-local matching on the pixel-level feature map of the T-th frame and the foreground pixel-level feature map and background pixel-level feature map of the (T-1)-th frame, to obtain the second matching feature map of the T-th frame.

In some alternative implementations of this embodiment, the apparatus 700 for extracting a feature further includes: a first pooling module, configured to perform global pooling on the foreground pixel-level feature map and background pixel-level feature map of the reference frame on a feature channel, to obtain a foreground instance-level feature vector and background instance-level feature vector of the reference frame; a second pooling module, configured to perform global pooling on the foreground pixel-level feature map and background pixel-level feature map of the (T-1)-th frame on a feature channel, to obtain a foreground instance-level feature vector and background instance-level feature vector of the (T-1)-th frame; and a second fusing module, configured to fuse the foreground instance-level feature vector and background instance-level feature vector of the reference frame and the foreground instance-level feature vector and background instance-level feature vector of the (T-1)-th frame, to obtain a fused instance-level feature vector.

In some alternative implementations of this embodiment, the apparatus 700 for extracting a feature further includes: a predicting module, configured to input a low-level pixel-level feature map of the T-th frame, the fused pixel-level feature map, and the fused instance-level feature vector into a collaborative ensemble-learning model, to obtain a predicted object segmentation annotation image of the T-th frame.

According to the method for extracting a feature provided by the embodiments of the present disclosure, the feature of a next frame is extracted in combination with the characteristic of a previous frame, such that the information between the previous frame and the next frame can be better extracted.

In the technical solution of the present disclosure, the acquisition, storage, application, etc. of the personal information of a user all comply with the provisions of the relevant laws and regulations, and do not violate public order and good customs.

According to an embodiment of the present disclosure, the present disclosure further provides an electronic device, a readable storage medium, and a computer program product.

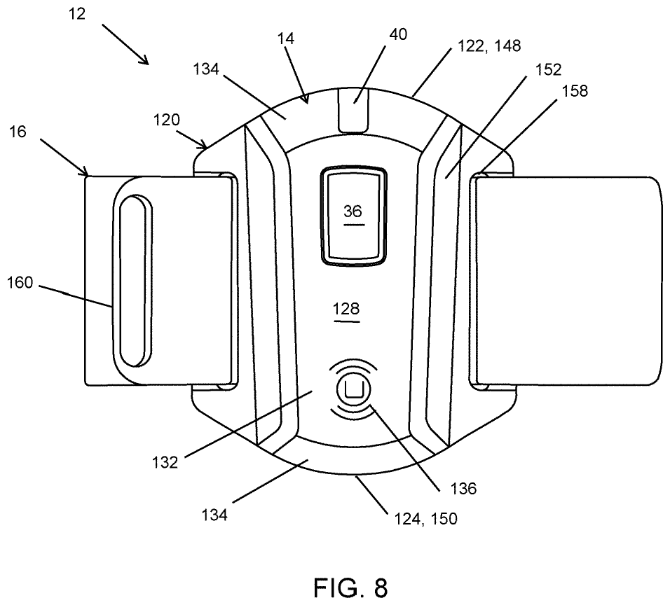

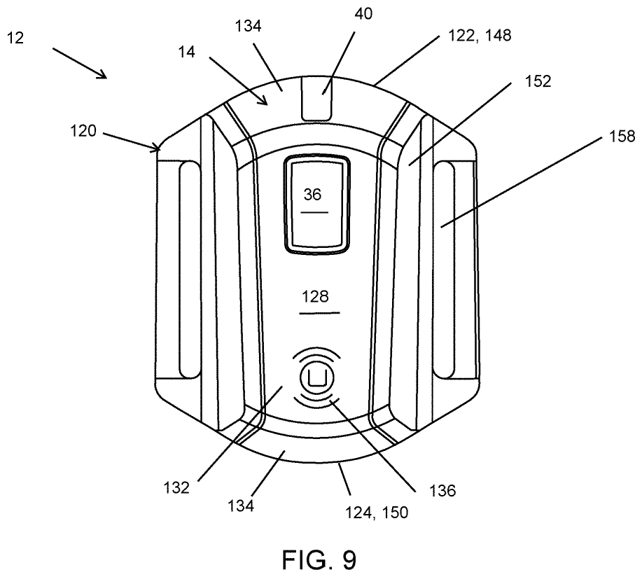

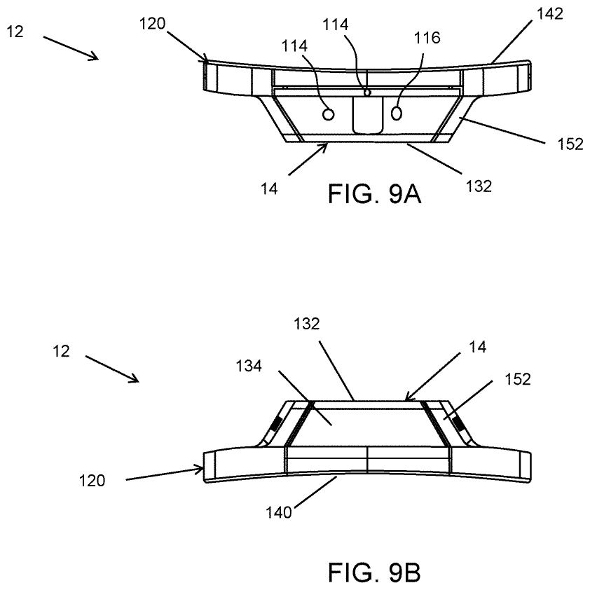

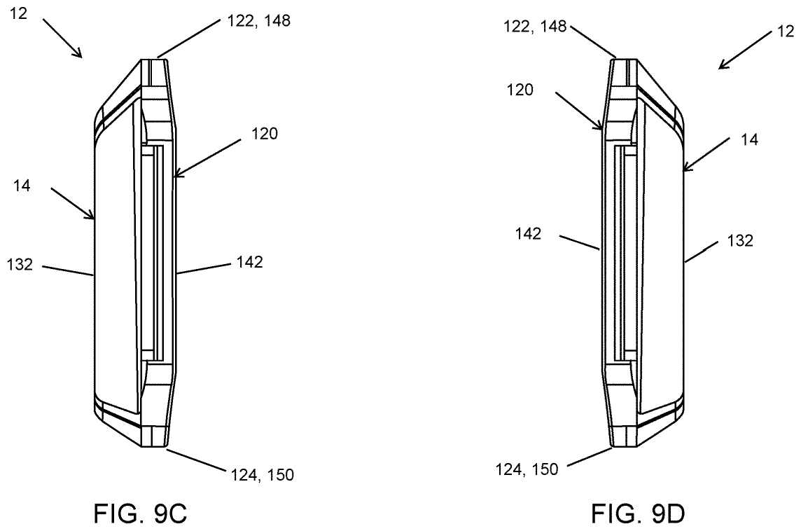

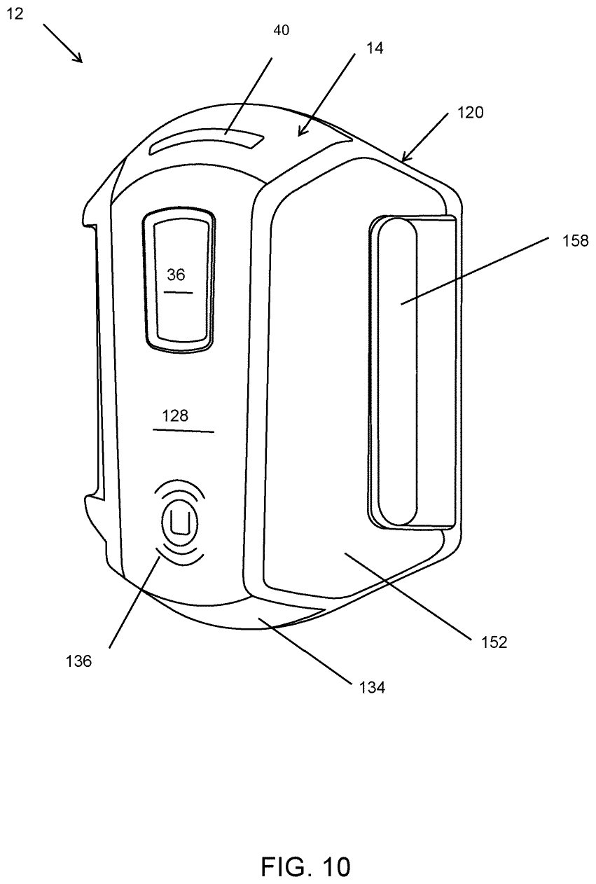

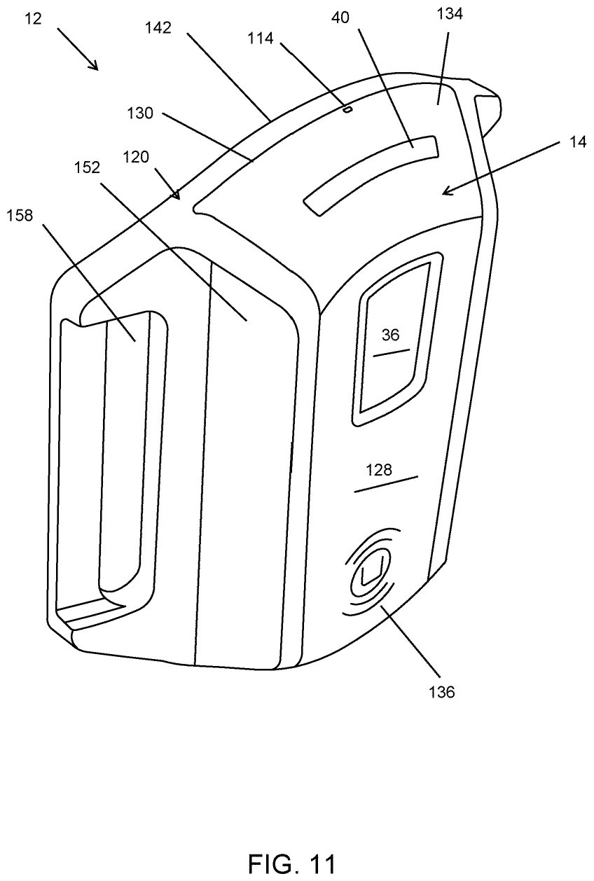

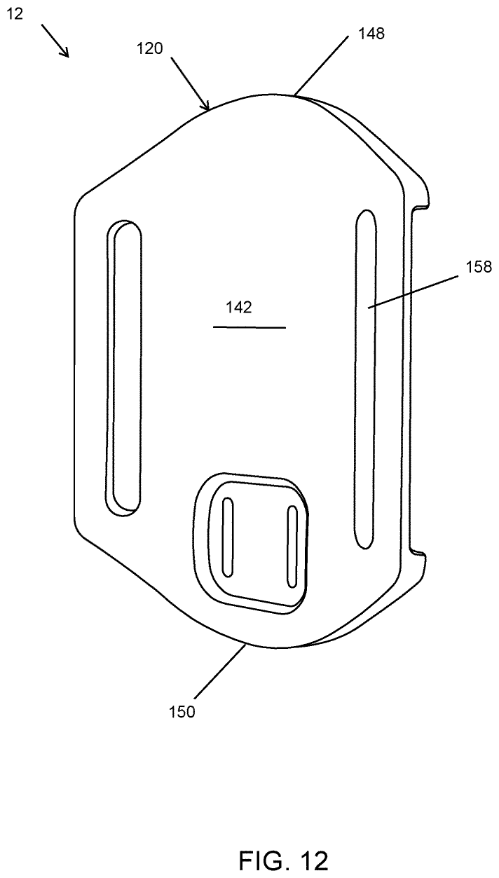

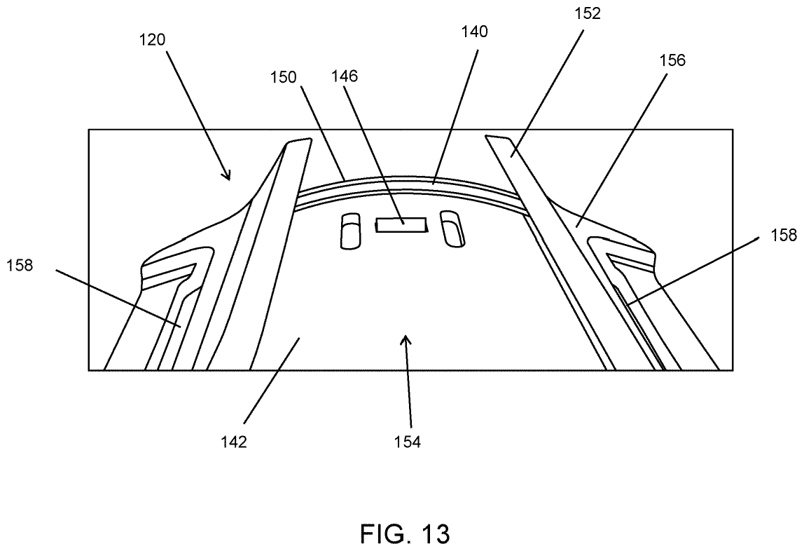

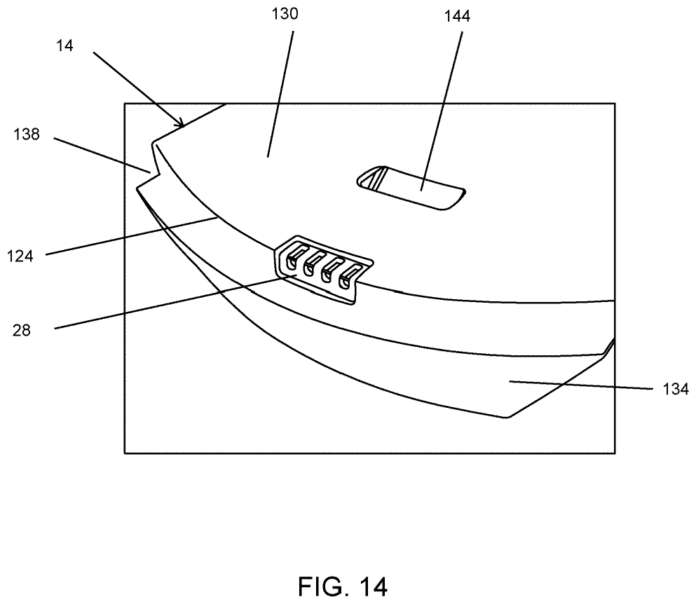

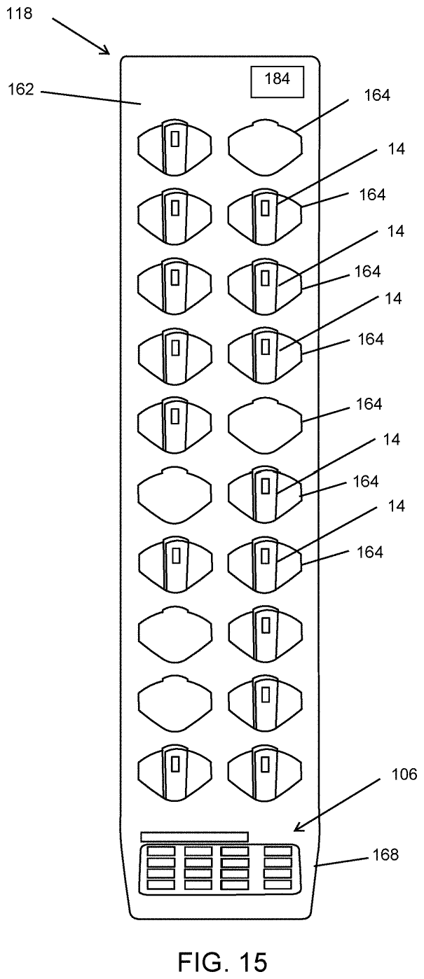

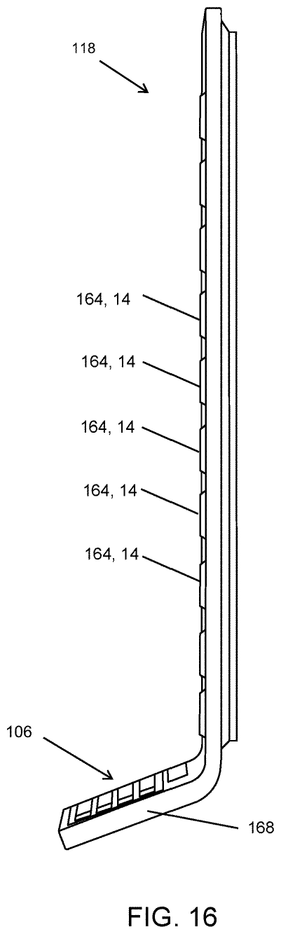

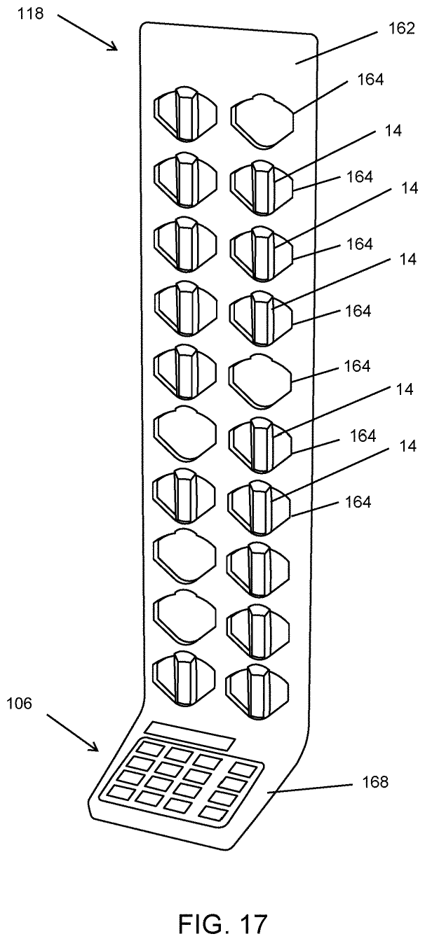

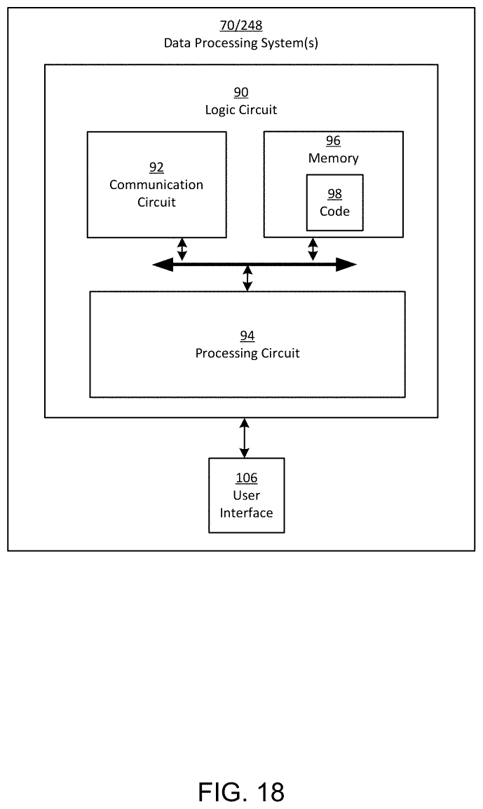

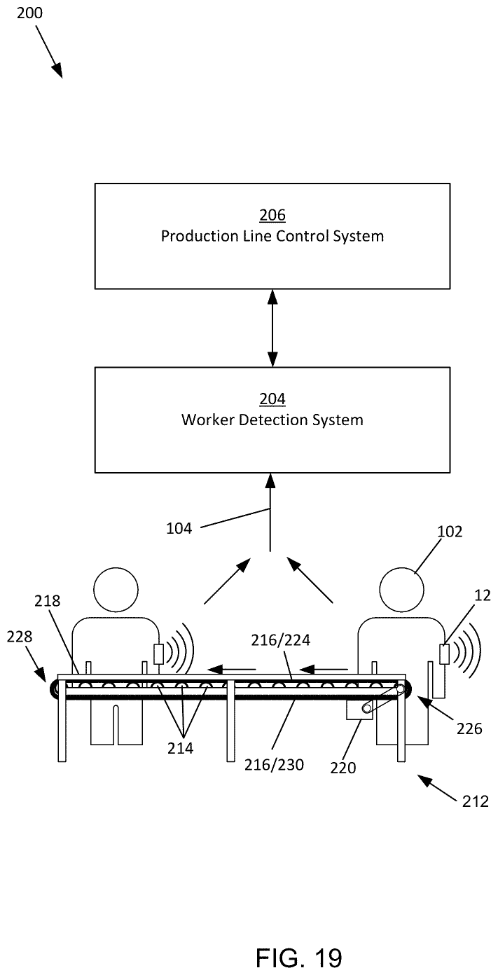

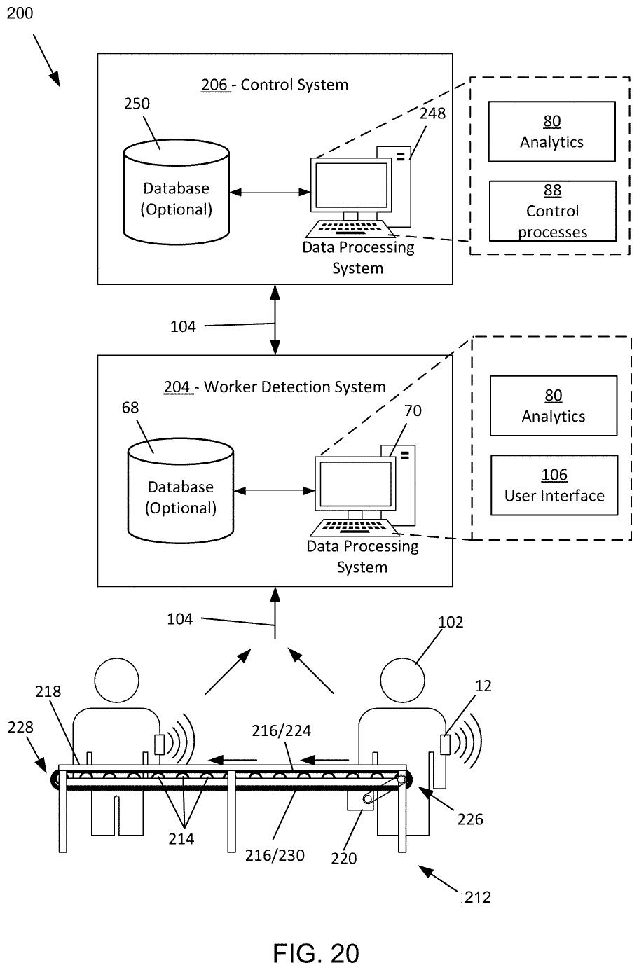

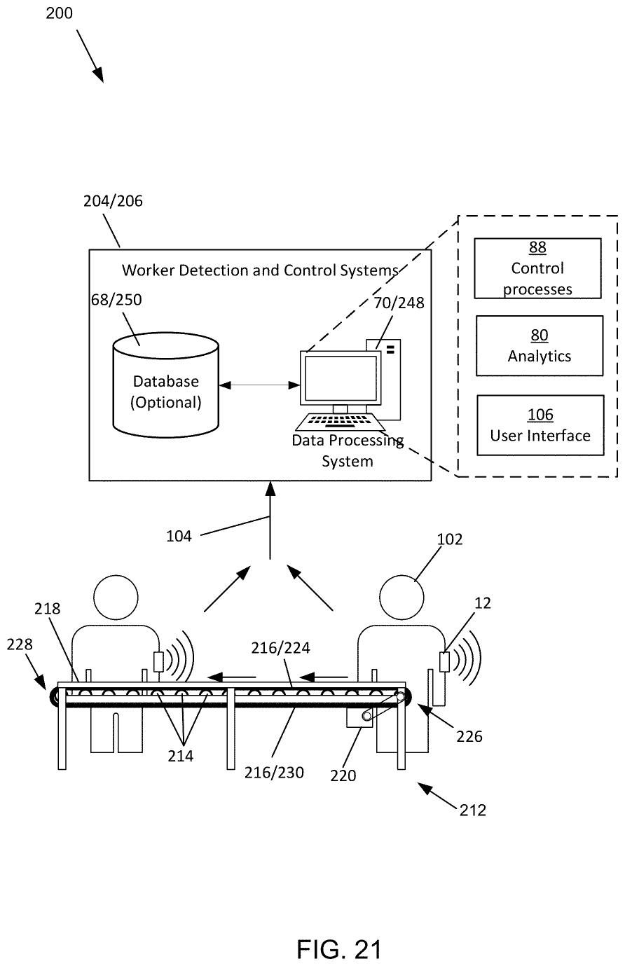

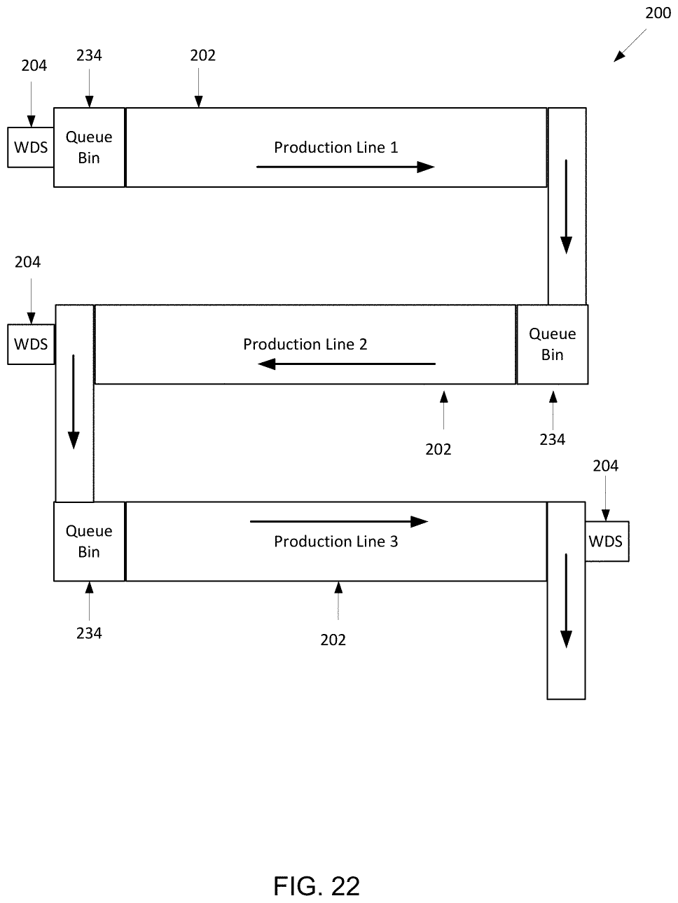

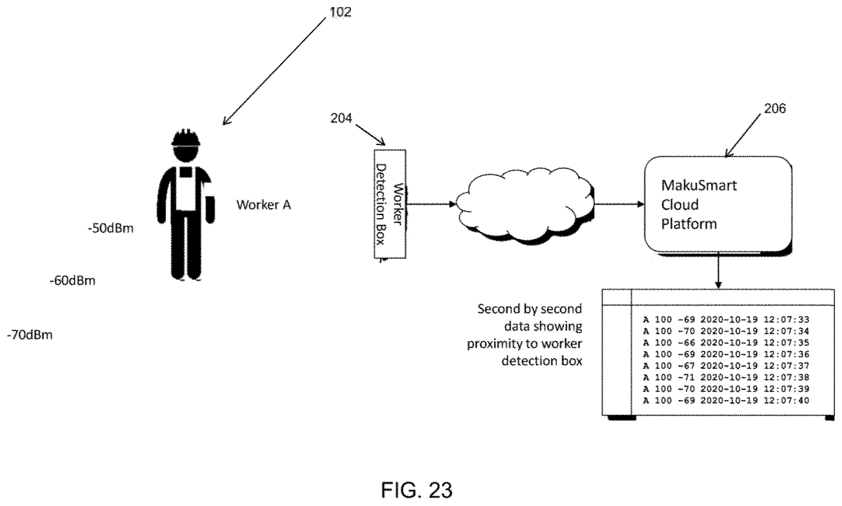

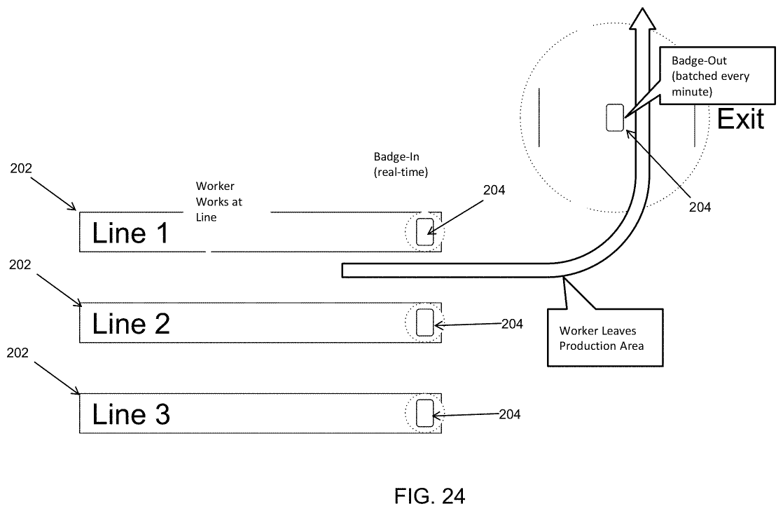

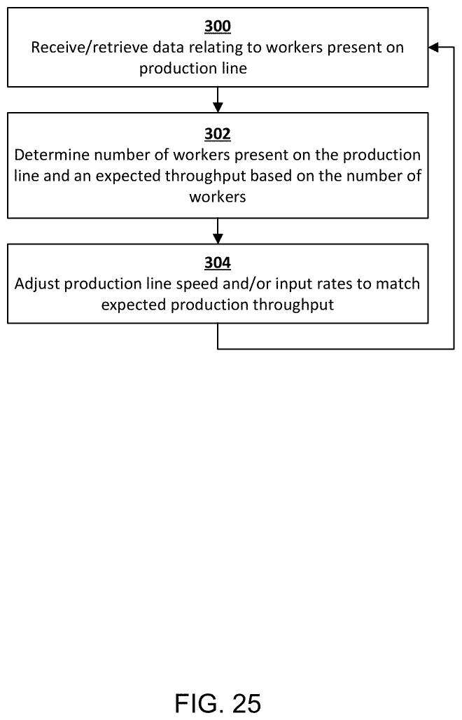

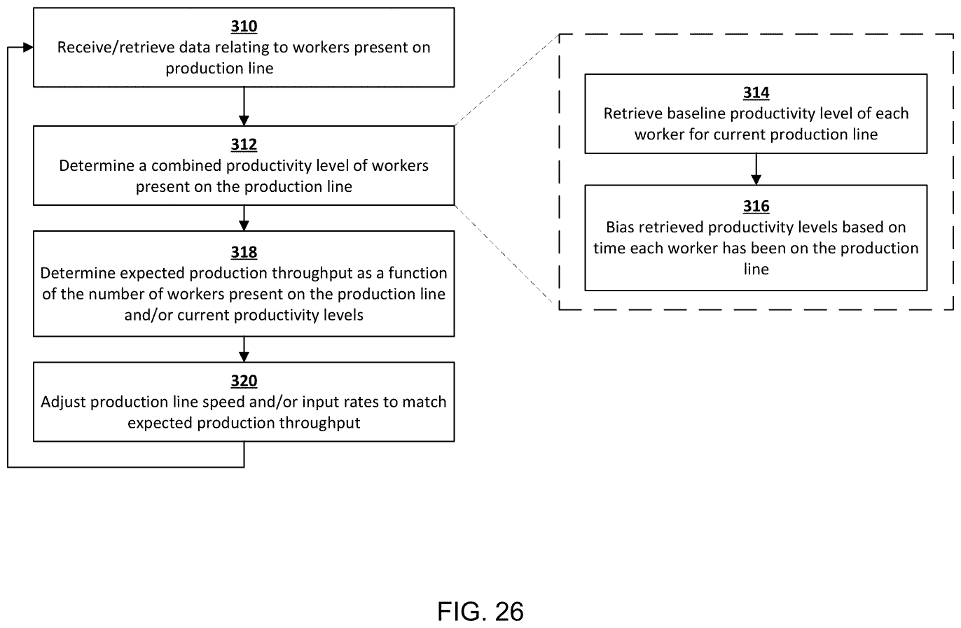

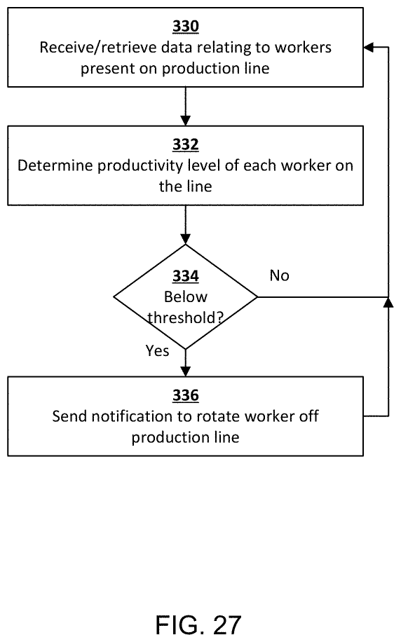

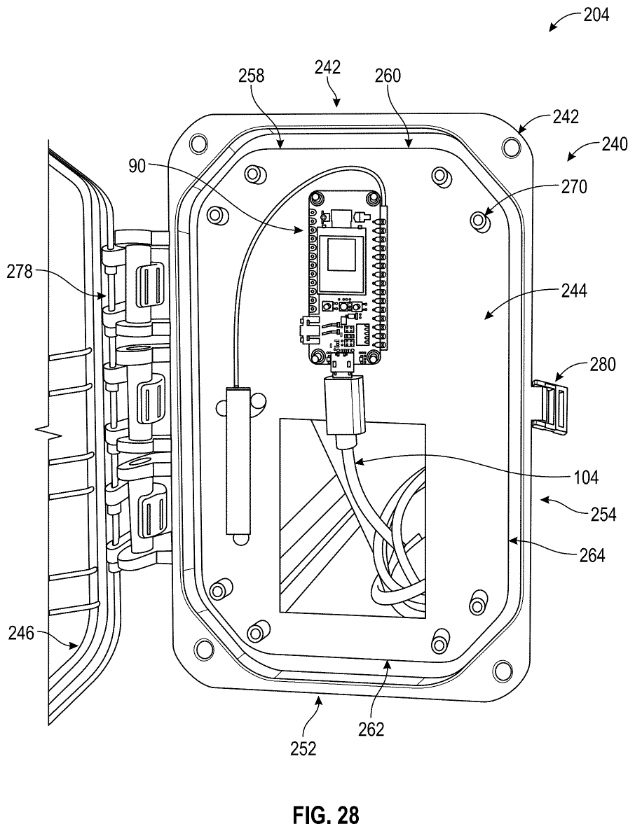

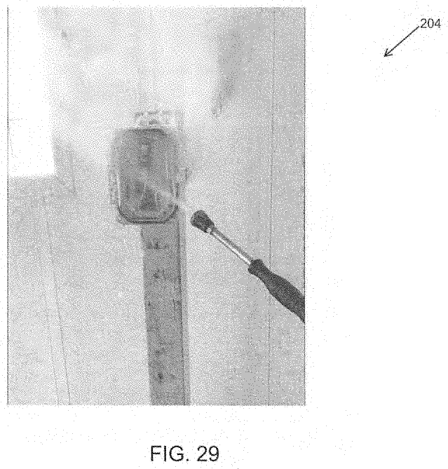

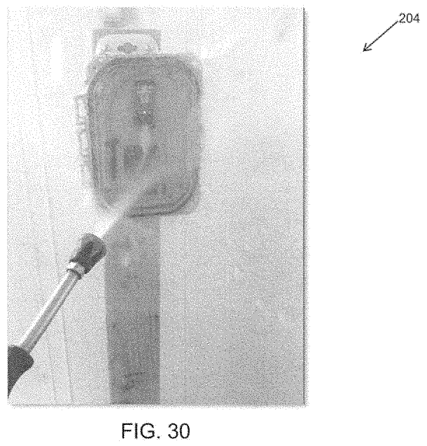

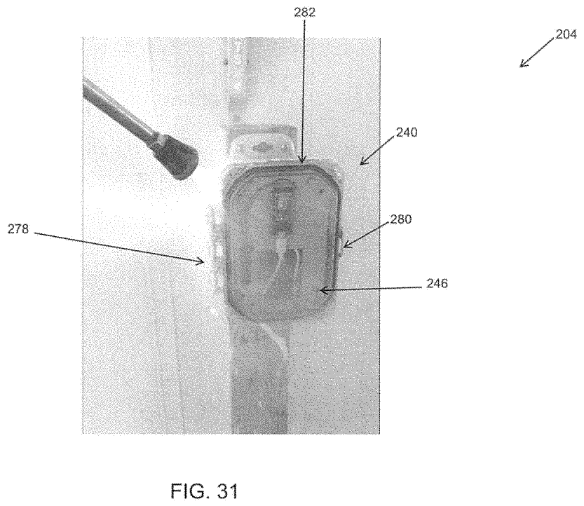

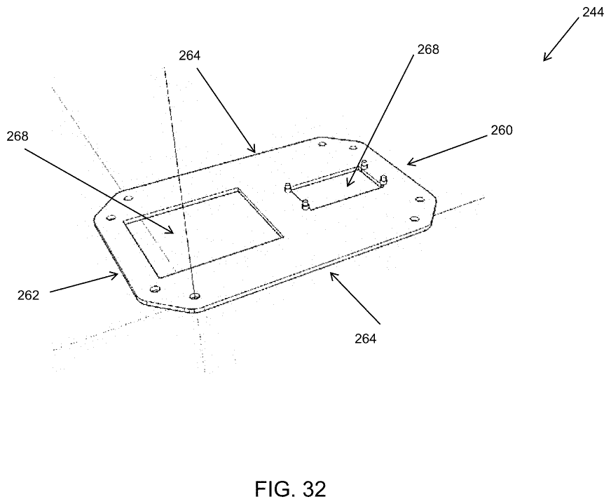

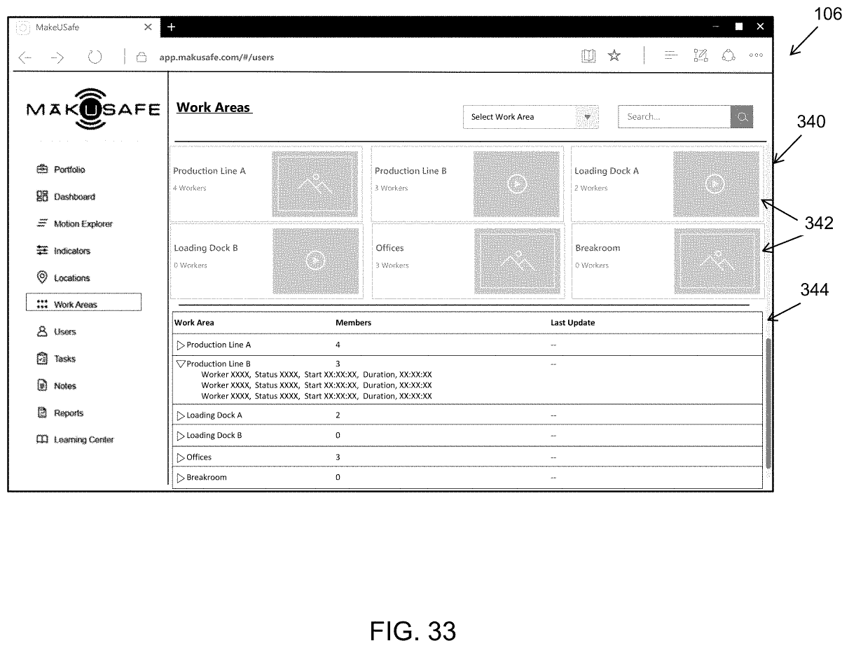

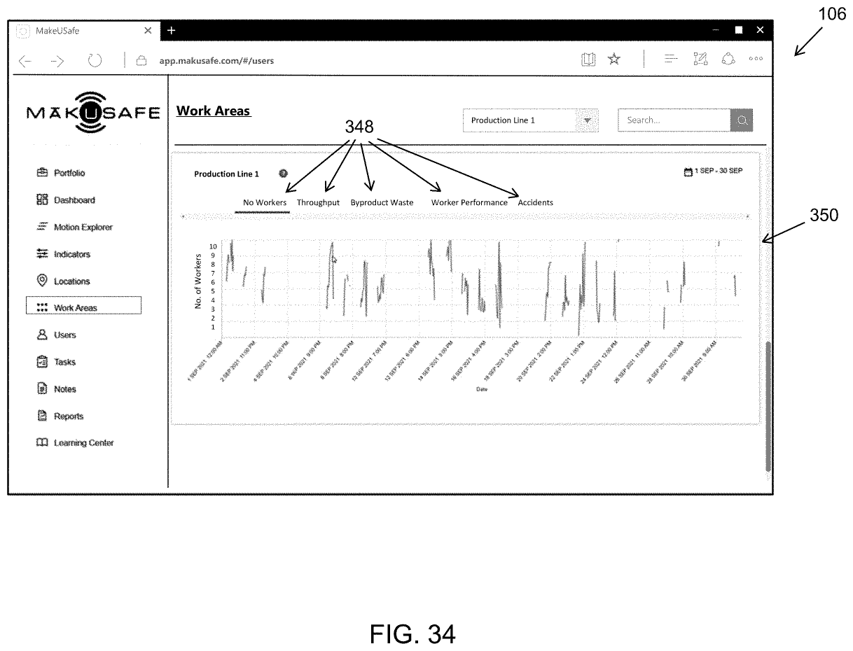

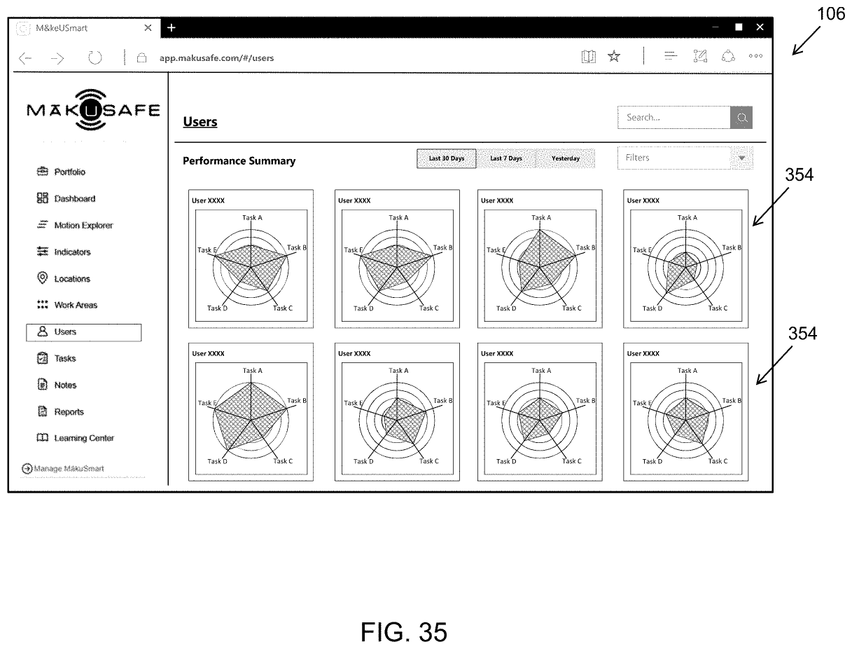

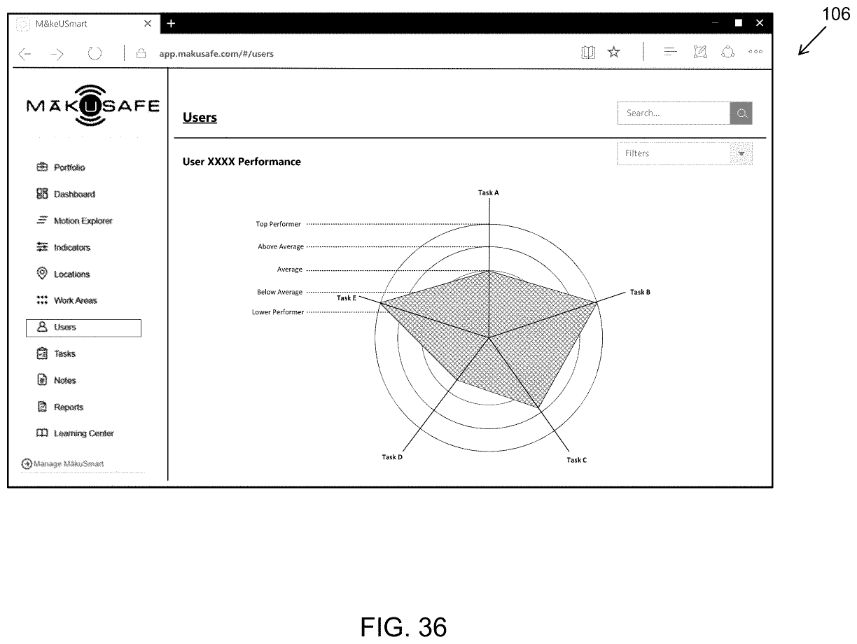

FIG. 8 is a schematic block diagram of an exemplary electronic device 800 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processors, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 8, the electronic device 800 includes a computing unit 801, which may execute various appropriate actions and processes in accordance with a computer program stored in a read-only memory (ROM) 802 or a computer program loaded into a random access memory (RAM) 803 from a storage unit 808. The RAM 803 also stores various programs and data required by operations of the device 800. The computing unit 801, the ROM 802 and the RAM 803 are connected to each other through a bus 804. An input/output (I/O) interface 505 is also connected to the bus 804.

The following components in the electronic device 800 are connected to the I/O interface 805: an input unit 806, for example, a keyboard and a mouse; an output unit 807, for example, various types of displays and a speaker; a storage unit 808, for example, a magnetic disk and an optical disk; and a communication unit 809, for example, a network card, a modem, a wireless communication transceiver. The communication unit 809 allows the device 800 to exchange information/data with an other device through a computer network such as the Internet and/or various telecommunication networks.

The computing unit 801 may be various general-purpose and/or special-purpose processing assemblies having processing and computing capabilities. Some examples of the computing unit 801 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computing unit 801 performs the various methods and processes described above, for example, the method for extracting a feature. For example, in some embodiments, the method for extracting a feature may be implemented as a computer software program, which is tangibly included in a machine readable medium, for example, the storage unit 808. In some embodiments, part or all of the computer program may be loaded into and/or installed on the device 800 via the ROM 802 and/or the communication unit 809. When the computer program is loaded into the RAM 803 and executed by the computing unit 801, one or more steps of the above method for extracting a feature may be performed. Alternatively, in other embodiments, the computing unit 801 may be configured to perform the method for extracting a feature through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (AS SP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, a distributed system server, or a server combined with a blockchain.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for extracting a feature, comprising:
acquiring a predicted object segmentation annotation image of a (T-1)-th frame in a video and a pixel-level feature map of a T-th frame in the video, T being a positive integer greater than 2;
performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame; and
performing a convolution on the mapping feature map of the T-th frame using a convolution kernel of the mapping feature map of the (T-1)-th frame, to obtain a score map of the T-th frame, wherein each point of the score map represents a similarity between each position of the pixel-level feature map of the T-th frame and the predicted object segmentation annotation image of the (T-1)-th frame.

2. The method according to claim 1, wherein the performing respectively feature mapping on the predicted object segmentation annotation image of the (T-1)-th frame and the pixel-level feature map of the T-th frame comprises:
using a convolutional layer and a pooling layer in a convolutional neural network to respectively map the predicted object segmentation annotation image of the (T-1)-th frame and the pixel-level feature map of the T-th frame to a preset feature space.

3. The method according to claim 2, further comprising:
acquiring a pixel-level feature map of a reference frame in the video and performing matching on the pixel-level feature map of the T-th frame and the pixel-level feature map of the reference frame to obtain a first matching feature map of the T-th frame, wherein the reference frame has an object segmentation annotation image;
acquiring a pixel-level feature map of the (T-1)-th frame and performing matching on the pixel-level feature map of the T-th frame and the pixel-level feature map of the (T-1)-th frame to obtain a second matching feature map of the T-th frame; and
fusing the score map, the first matching feature map and the second matching feature map of the T-th frame to obtain a fused pixel-level feature map.

4. The method according to claim 3, wherein the acquiring a pixel-level feature map of a reference frame in the video and performing matching on the pixel-level feature map of the T-th frame and the pixel-level feature map of the reference frame to obtain a first matching feature map of the T-th frame comprises:
down-sampling an object segmentation annotation image of the reference frame to obtain a mask of the reference frame;
inputting the reference frame into a pre-trained feature extraction network to obtain the pixel-level feature map of the reference frame;
performing a pixel-level separation on the pixel-level feature map of the reference frame using the mask of the reference frame to obtain a foreground pixel-level feature map and background pixel-level feature map of the reference frame; and
performing foreground-background global matching on the pixel-level feature map of the T-th frame and the foreground pixel-level feature map and background pixel-level feature map of the reference frame, to obtain the first matching feature map of the T-th frame.

5. The method according to claim 1, further comprising:
acquiring a pixel-level feature map of a reference frame in the video and performing matching on the pixel-level feature map of the T-th frame and the pixel-level feature map of the reference frame to obtain a first matching feature map of the T-th frame, wherein the reference frame has an object segmentation annotation image;
acquiring a pixel-level feature map of the (T-1)-th frame and performing matching on the pixel-level feature map of the T-th frame and the pixel-level feature map of the (T-1)-th frame to obtain a second matching feature map of the T-th frame; and
fusing the score map, the first matching feature map and the second matching feature map of the T-th frame to obtain a fused pixel-level feature map.

6. The method according to claim 5, wherein the acquiring a pixel-level feature map of the (T-1)-th frame and performing matching on the pixel-level feature map of the T-th frame and the pixel-level feature map of the (T-1)-th frame to obtain a second matching feature map of the T-th frame comprises:
down-sampling the predicted object segmentation annotation image of the (T-1)-th frame to obtain a mask of the (T-1)-th frame;
inputting the (T-1)-th frame into the pre-trained feature extraction network to obtain the pixel-level feature map of the (T-1)-th frame;
performing a pixel-level separation on the pixel-level feature map of the (T-1)-th frame using the mask of the (T-1)-th frame to obtain a foreground pixel-level feature map and background pixel-level feature map of the (T-1)-th frame; and
performing foreground-background multi-local matching on the pixel-level feature map of the T-th frame and the foreground pixel-level feature map and background pixel-level feature map of the (T-1)-th frame, to obtain the second matching feature map of the T-th frame.

7. The method according to claim 6, further comprising:
performing global pooling on the foreground pixel-level feature map and background pixel-level feature map of the reference frame on a feature channel, to obtain a foreground instance-level feature vector and background instance-level feature vector of the reference frame;
performing global pooling on the foreground pixel-level feature map and background pixel-level feature map of the (T-1)-th frame on a feature channel, to obtain a foreground instance-level feature vector and background instance-level feature vector of the (T-1)-th frame; and
fusing the foreground instance-level feature vector and background instance-level feature vector of the reference frame and the foreground instance-level feature vector and background instance-level feature vector of the (T-1)-th frame, to obtain a fused instance-level feature vector.

8. The method according to claim 7, further comprising:
inputting a low-level pixel-level feature map of the T-th frame, the fused pixel-level feature map, and the fused instance-level feature vector into a collaborative ensemble-learning model, to obtain a predicted object segmentation annotation image of the T-th frame.

9. An electronic device, comprising:
at least one processor; and
a memory, in communication with the at least one processor,
wherein the memory stores instructions executable by the at least one processor, and the instructions are executed by the at least one processor, to enable the at least one processor to perform operations, the operations comprising:
acquiring a predicted object segmentation annotation image of a (T-1)-th frame in a video and a pixel-level feature map of a T-th frame in the video, T being a positive integer greater than 2;
performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame; and
performing a convolution on the mapping feature map of the T-th frame using a convolution kernel of the mapping feature map of the (T-1)-th frame, to obtain a score map of the T-th frame, wherein each point of the score map represents a similarity between each position of the pixel-level feature map of the T-th frame and the predicted object segmentation annotation image of the (T-1)-th frame.

10. The electronic device according to claim 9, wherein the performing respectively feature mapping on the predicted object segmentation annotation image of the (T-1)-th frame and the pixel-level feature map of the T-th frame comprises:
using a convolutional layer and a pooling layer in a convolutional neural network to respectively map the predicted object segmentation annotation image of the (T-1)-th frame and the pixel-level feature map of the T-th frame to a preset feature space.

11. The electronic device according to claim 10, further comprising:
acquiring a pixel-level feature map of a reference frame in the video and performing matching on the pixel-level feature map of the T-th frame and the pixel-level feature map of the reference frame to obtain a first matching feature map of the T-th frame, wherein the reference frame has an object segmentation annotation image;
acquiring a pixel-level feature map of the (T-1)-th frame and performing matching on the pixel-level feature map of the T-th frame and the pixel-level feature map of the (T-1)-th frame to obtain a second matching feature map of the T-th frame; and
fusing the score map, the first matching feature map and the second matching feature map of the T-th frame to obtain a fused pixel-level feature map.

12. The electronic device according to claim 9, further comprising:
acquiring a pixel-level feature map of a reference frame in the video and performing matching on the pixel-level feature map of the T-th frame and the pixel-level feature map of the reference frame to obtain a first matching feature map of the T-th frame, wherein the reference frame has an object segmentation annotation image;
acquiring a pixel-level feature map of the (T-1)-th frame and performing matching on the pixel-level feature map of the T-th frame and the pixel-level feature map of the (T-1)-th frame to obtain a second matching feature map of the T-th frame; and
fusing the score map, the first matching feature map and the second matching feature map of the T-th frame to obtain a fused pixel-level feature map.

13. The electronic device according to claim 12, wherein the acquiring a pixel-level feature map of a reference frame in the video and performing matching on the pixel-level feature map of the T-th frame and the pixel-level feature map of the reference frame to obtain a first matching feature map of the T-th frame comprises:
down-sampling an object segmentation annotation image of the reference frame to obtain a mask of the reference frame;
inputting the reference frame into a pre-trained feature extraction network to obtain the pixel-level feature map of the reference frame;
performing a pixel-level separation on the pixel-level feature map of the reference frame using the mask of the reference frame to obtain a foreground pixel-level feature map and background pixel-level feature map of the reference frame; and
performing foreground-background global matching on the pixel-level feature map of the T-th frame and the foreground pixel-level feature map and background pixel-level feature map of the reference frame, to obtain the first matching feature map of the T-th frame.

14. The electronic device according to claim 13, wherein the acquiring a pixel-level feature map of the (T-1)-th frame and performing matching on the pixel-level feature map of the T-th frame and the pixel-level feature map of the (T-1)-th frame to obtain a second matching feature map of the T-th frame comprises:
down-sampling the predicted object segmentation annotation image of the (T-1)-th frame to obtain a mask of the (T-1)-th frame;
inputting the (T-1)-th frame into the pre-trained feature extraction network to obtain the pixel-level feature map of the (T-1)-th frame;
performing a pixel-level separation on the pixel-level feature map of the (T-1)-th frame using the mask of the (T-1)-th frame to obtain a foreground pixel-level feature map and background pixel-level feature map of the (T-1)-th frame; and
performing foreground-background multi-local matching on the pixel-level feature map of the T-th frame and the foreground pixel-level feature map and background pixel-level feature map of the (T-1)-th frame, to obtain the second matching feature map of the T-th frame.

15. The electronic device according to claim 14, further comprising:
performing global pooling on the foreground pixel-level feature map and background pixel-level feature map of the reference frame on a feature channel, to obtain a foreground instance-level feature vector and background instance-level feature vector of the reference frame;
performing global pooling on the foreground pixel-level feature map and background pixel-level feature map of the (T-1)-th frame on a feature channel, to obtain a foreground instance-level feature vector and background instance-level feature vector of the (T-1)-th frame; and
fusing the foreground instance-level feature vector and background instance-level feature vector of the reference frame and the foreground instance-level feature vector and background instance-level feature vector of the (T-1)-th frame, to obtain a fused instance-level feature vector.

16. The electronic device according to claim 15, further comprising:
inputting a low-level pixel-level feature map of the T-th frame, the fused pixel-level feature map, and the fused instance-level feature vector into a collaborative ensemble-learning model, to obtain a predicted object segmentation annotation image of the T-th frame.

17. A non-transitory computer readable storage medium, storing a computer instruction, wherein the computer instruction is used to cause a computer to perform operations, the operations comprising:
acquiring a predicted object segmentation annotation image of a (T-1)-th frame in a video and a pixel-level feature map of a T-th frame in the video, T being a positive integer greater than 2;
performing respectively feature mapping on the predicted object segmentation annotation image of the (T-1)-th frame and the pixel-level feature map of the T-th frame, to obtain a mapping feature map of the (T-1)-th frame and a mapping feature map of the T-th frame; and
performing a convolution on the mapping feature map of the T-th frame using a convolution kernel of the mapping feature map of the (T-1)-th frame, to obtain a score map of the T-th frame, wherein each point of the score map represents a similarity between each position of the pixel-level feature map of the T-th frame and the predicted object segmentation annotation image of the (T-1)-th frame.

18. The non-transitory computer readable storage medium according to claim 17, wherein the performing respectively feature mapping on the predicted object segmentation annotation image of the (T-1)-th frame and the pixel-level feature map of the T-th frame comprises:
using a convolutional layer and a pooling layer in a convolutional neural network to respectively map the predicted object segmentation annotation image of the (T-1)-th frame and the pixel-level feature map of the T-th frame to a preset feature space.

19. The non-transitory computer readable storage medium according to claim 17, further comprising:
acquiring a pixel-level feature map of a reference frame in the video and performing matching on the pixel-level feature map of the T-th frame and the pixel-level feature map of the reference frame to obtain a first matching feature map of the T-th frame, wherein the reference frame has an object segmentation annotation image;
acquiring a pixel-level feature map of the (T-1)-th frame and performing matching on the pixel-level feature map of the T-th frame and the pixel-level feature map of the (T-1)-th frame to obtain a second matching feature map of the T-th frame; and
fusing the score map, the first matching feature map and the second matching feature map of the T-th frame to obtain a fused pixel-level feature map.

20. The non-transitory computer readable storage medium according to claim 17, wherein the acquiring a pixel-level feature map of a reference frame in the video and performing matching on the pixel-level feature map of the T-th frame and the pixel-level feature map of the reference frame to obtain a first matching feature map of the T-th frame comprises:
down-sampling an object segmentation annotation image of the reference frame to obtain a mask of the reference frame;
inputting the reference frame into a pre-trained feature extraction network to obtain the pixel-level feature map of the reference frame;
performing a pixel-level separation on the pixel-level feature map of the reference frame using the mask of the reference frame to obtain a foreground pixel-level feature map and background pixel-level feature map of the reference frame; and
performing foreground-background global matching on the pixel-level feature map of the T-th frame and the foreground pixel-level feature map and background pixel-level feature map of the reference frame, to obtain the first matching feature map of the T-th frame.
